(19) United States
(12) Patent Application Publication
(10) Pub. No.: US 2020/0166456 A1
(43) Pub. Date: May 28, 2020

(54) SUPER-RESOLUTION OPTICAL IMAGING OF NON-FLUORESCENT SPECIES

(71) Applicant: CORNELL UNIVERSITY, Ithaca, NY (US)

(72) Inventors: Peng Chen, Ithaca, NY (US); Xianwen Mao, Ithaca, NY (US)

(21) Appl. No.: 16/584,219

(22) Filed: Sep. 26, 2019

Related U.S. Application Data
(60) Provisional application No. 62/737,195, filed on Sep. 27, 2018.

(51) Int. Cl. G01N 21/64; G02B 27/58

(52) U.S. Cl. CPC G01N 21/6428; G01N 21/6458; G02B 27/58

(57) ABSTRACT

A method for super-resolution imaging of interactions between a non-fluorescent species and a material, comprising: (i) contacting the material with a fluorescent species, wherein the fluorescent species selectively interacts with specific sites in the material; (ii) inducing fluorescence in the fluorescent species, and measuring a first fluorescence signal over an area of the material to provide a first quantified distribution map of the fluorescent species in the material; (iii) further contacting the material with a competitive non-fluorescent species that selectively interacts with the same specific sites as the fluorescent species; (iv) measuring a second fluorescence signal of the fluorescent species over an area of the material to provide a second quantified distribution map of the fluorescent species in the material; and (v) calculating the difference in intensity, wavelength, or blinking frequency between the first and second fluorescence signals over the area of material to provide a difference quantified distribution map.

### CROSS REFERENCE TO RELATED APPLICATIONS

This application claims the benefit of priority from U.S. Provisional Application No. 62/737,195, filed on Sep. 27, 2018, which is herein incorporated by reference in its entirety.

### GOVERNMENT SUPPORT

This invention was made with Government support under Grant Number W911NF-17-1-0590 and Grant Number W911NF-18-1-0217, both awarded by the Army Research Office. The United States Government has certain rights in the invention.

### FIELD OF THE INVENTION

The present invention generally relates to methods for super-resolution optical imaging, and more particularly, super-resolution fluorescence microscopy for imaging of non-fluorescent species.

### BACKGROUND OF THE INVENTION

The development of high-resolution imaging techniques, such as electron and X-ray microscopy-based and scanning probe-based approaches, has brought tremendous advances to the physical and life sciences. Among them, optical microscopy-based imaging methods are among the most widely used; they allow for non-invasive, real-time in situ observation of structures and dynamics under realistic conditions (for example, in liquid environments), which is challenging to achieve using non-optical methods that usually operate either in vacuo or under ex situ conditions. However, conventional optical microscopy has a diffraction-limited resolution of about 200-300 nm. This diffraction limit was circumvented recently by super-resolved fluorescence microscopy (which reached a resolution of ˜10 nm), including techniques that are based on point-spread-function engineering, such as stimulated emission depletion microscopy, or on single-molecule localization, such as photoactivated localization microscopy, and stochastic optical reconstruction microscopy.

These super-resolution techniques have revolutionized many research fields, particularly biology, not just because of their resolution, but also their ease in experimental implementation. More recently, single-molecule-localization-based methods have been applied to image fluorogenic surface reactions with nanometer resolution, yielding site-specific activity and dynamics within single catalyst particles (e.g., N. Zou, et al. Nature Chem. 20, 607-614, 2018; and Z. Ristanovic, et al., J. Am. Chem. Soc. 138, 13586-13596, 2016). However, a significant drawback of these super-resolution imaging techniques is that they can only study entities or processes that include fluorescence. For this reason, a vast number of species and mechanisms that are non-fluorescent, including most chemical and biological species and mechanisms, cannot be imaged by current super-resolution optical imaging techniques. Thus, there would be a significant advantage in a method that could achieve super-resolution optical imaging of species and processes that are non-fluorescent.

### SUMMARY OF THE INVENTION

The present disclosure describes a super-resolution optical imaging technique that, by exploiting a competition strategy, is able to image non-fluorescent species and processes at the same nanometer resolutions of super-resolution optical imaging techniques of the art. The super-resolution imaging technique described herein is also referred to as “COMPEITS”. Given the vast number of non-fluorescent species that cannot be imaged by conventional fluorescence-based super-resolution imaging techniques, the COMPEITS method described herein represents a significant advance in the art of super-resolution imaging. Moreover, the COMPEITS method can be applied to imaging of a diverse number of materials and processes, including, for example, inorganic materials (e.g., catalysts), and organic materials (e.g., polymers), including biological materials and processes (e.g., proteins, nucleic acids, neurotransmitters, and neurotransmitter receptors).

More specifically, the COMPEITS method is a method for super-resolution imaging of interactions between a non-fluorescent species and a material, involving the following steps: (i) contacting the material with a fluorescent species, wherein the fluorescent species selectively interacts with specific sites in the material; (ii) inducing fluorescence in the fluorescent species, and measuring a first fluorescence signal over an area of the material to provide a first quantified distribution map of the fluorescent species in the material, wherein the resolution is less than 100 nm; (iii) further contacting the material with a competitive non-fluorescent species that selectively interacts with the same specific sites as the fluorescent species; (iv) inducing fluorescence in the fluorescent species while in the presence of the competitive non-fluorescent species, and measuring a second fluorescence signal over an area of the material to provide a second quantified distribution map of the fluorescent species in the material, wherein the resolution is less than 100 nm; and (v) calculating the difference in intensity, wavelength, or blinking frequency between the first and second fluorescence signals over the area of material to provide a difference quantified distribution map based on the difference in signal intensity, wavelength, or blinking frequency between the first and second fluorescence signals over the area of material.

### BRIEF DESCRIPTION OF THE FIGURES

FIGS. 1A-1E demonstrate the use of COMPEITS for elucidating a surface reaction. The figures are described as follows: FIG. 1A is a schematic of the COMPEITS imaging experimental set-up. FIG. 1B shows a competitive reaction process investigated by COMPEITS and the instrumental settings, i.e., wide-field fluorescence microscopy in a photoelectrocatalytic microfluidic cell via two-laser epifluorescence illumination. Here, a catalyst particle can catalyze both a non-fluorescent reaction and an auxiliary fluorogenic reaction; the fluorescent signals collected depend on the degree of competition between the two reactions. CE, counter electrode; RE, reference electrode. FIG. 1C shows target and auxiliary reactions. FIG. 1D shows time-dependent (0-40 min, indicated by the arrows) absorption of quinone (blue) and fluorescence of resorufin (red) during simultaneous photoelectrocatalysis of the two competing reactions on bulk BiVO₄ films, which shows that the products of the two reactions were generated under this catalytic condition. The initial [HQ] and [AR] are 500 μM and 40 μM, respectively. FIG. 1E shows the HQ or AR oxidation rate (blue or red symbols) versus [HQ], which demonstrates the competition between the two reactions. The lines are fits with equation (1′). Error bars represent the standard deviation.

FIGS. 2A-2K demonstrate COMPEITS imaging of the photoelectrooxidation of HQ on single BiVO₄ particles. The figures are described as follows: FIG. 2A shows an image plot (that is, a two-dimensional (2D) histogram) of nₚ over 22.5 minutes without HQ. FIG. 2B, panels bi-biv, show image plots of nₚ over 22.5 minutes with 50 μM (bi), 100 μM (bii), 250 μM (biii) and 500 μM (biv) HQ. In FIGS. 2A and 2B, [AR]=50 nM; the bin size is 33×33 nm²; and white lines are structural contours determined from the SEM image in FIG. 2E. FIG. 2C, panels ci-civ, show images derived from Δnₚ between FIGS. 2A and 2B. White/null pixels represent the occasional negative values. FIG. 2D, panels di-div, show COMPEITS images derived from Δ(nₚ⁻¹) between FIGS. 2A and 2B. White/null pixels represent the occasional negative values or infinities due to 1/0 (that is, the bin has zero detected product molecules). FIG. 2E is a SEM image of the BiVO₄ particle in FIGS. 2A-2D. FIG. 2F is an illustration of the basal {010} and lateral {110} facets. FIG. 2G is an illustration showing the type-I and type-II edge regions. For the type-I region, the width on either side of the black edge is chosen to be 50 nm, which is slightly larger than the localization error (˜40 nm). FIGS. 2H-2K are plots of the v_{AR}⁻¹ of the auxiliary reaction versus [HQ] at [AR]=50 nM for the basal {010} (FIG. 2H) and lateral {110} facets (FIG. 2I), and the type-I (FIG. 2J) and type-II edges (FIG. 2K). Solid circles represent the particle in FIGS. 2A-2E; open squares are the averages of 42 particles; lines are fits with equation (1′). All scale bars are 500 nm. All error bars are the s.e.m.

FIGS. 3A-3E demonstrate subparticle, facet-specific size and shape dependencies of HQ binding affinity. The figures are described as follows: FIGS. 3A and 3B (bottom left) show the 2D dependences of K_{HQ} on ξ and for the basal {010} (FIG. 3A) and lateral {110) facets (FIG. 3B), which demonstrates the decoupling of the dependency of K_{HQ} on L and ξ. Each circle represents one particle of a total of 42. The shaded surfaces are fits with equation (2′). For the basal {010} facet, β₁=0.11±0.05 μM⁻¹, β₂=8360±700 nm and β₃=3.06±0.66. For the lateral {110} facet, β₁=0.23±0.11 μM⁻¹, β₂=830±620 nm and β₃=2.65±0.56. Top left and bottom right of FIGS. 3A and 3B show the corresponding one-dimensional projections of K_{HQ} data onto the L and ξ axes, respectively, demonstrating that K_{HQ} is negatively correlated with L and ξ. Top right of FIGS. 3A and 3B shows the distribution of K_{HQ} of individual BiVO₄ particles, demonstrating that, on average, K_{HQ} is larger for the basal {010} facet than for the lateral {110} facet; μ is the particle-averaged K_{HQ}. FIGS. 3C-3E are plots showing the selected K_{HQ} ratios between the type-I edge and the basal {010} facet (FIG. 3C), the type-I edge and the lateral {110} facet (FIG. 3D), and the type-I and type-II edges (FIG. 3E) versus ξ. The error bars represent the s.d.

FIGS. 4A and 4B demonstrate the rational design of size- and shape-tunable BiVO₄ particles for optimal reactant adsorption. FIG. 4A, bottom-left, shows the two-dimensional (2D) dependencies of ω_{HQ}, which quantifies a particle's overall capability to adsorb HQ on its entire surface at the per-unit-mass level, on L and ξ. Each circle represents one particle of a total of 42 particles. The shaded surface represents predicted values using the fitted parameters βᵢ of dissected facets from FIGS. 3A and 3B. (I)-(V) designations denote the line profiles on the shaded surface, which are shown in the top and right panels. FIG. 4A, top, shows the L dependence of ω_{HQ} at selected ξ values (that is, line profiles (IV) and (V)), which demonstrates that plate-like particles display steeper decays with L than bipyramid-like particles. FIG. 4A, right, shows the ξ dependence of ω_{HQ} at selected L values (that is, line profiles (I)-(III)), which demonstrates three distinct ξ dependencies at different particle size regimes. FIG. 4B, top, shows a comparison of K_{HQ}^{{010}} and K_{HQ}^{{110}} values over the accessible ranges of L and ξ, showing that the relative magnitude between K_{HQ}^{{010}} and K_{HQ}^{{110}} depend on both L and ξ. FIG. 4B, bottom, shows a plot of K_{HQ}^{{010}}/K_{HQ}^{{110}} versus L and ξ. The yellow dashed line is where K_{HQ}^{{010}}=K_{HQ}^{{110}}.

### DETAILED DESCRIPTION OF THE INVENTION

The present disclosure is directed to methods for super-resolution optical imaging of interactions between a non-fluorescent species and a material, wherein the material may or may not be fluorescent. The term “super-resolution optical imaging” (or “SROM”) is meant herein to be synonymous with “super-resolved fluorescence microscopy” or “super-resolution fluorescence microscopy” and other similar terms of the art that refer to optical microscopy techniques that rely on fluorescence of a species under study to image the species at spatial resolutions below the diffraction limit permitted by conventional optical microscopy techniques. The development of SROM led to the 2014 chemistry Nobel Prize for Eric Betzig, Stefan Hell, and W. E. Moerner. Since then, numerous derivations of the technique have emerged to better suit specific applications. The presently described “COMPEITS” technique can be integrated with any of the SROM techniques currently known in the art, including ensemble techniques (e.g., stimulated emission depletion or structured illumination microscopy) and single molecule-based techniques (e.g., photoactivated localization microscopy, i.e., “PALM,” or stochastic optical reconstruction microscopy, i.e., “STORM”). Another SROM technique is super-resolution optical fluctuation imaging (SOFI). SROM and its variations are discussed in detail in, for example, B. O. Leung et al., Applied Spectroscopy, 65(9), 967-980, 2011; E. Betzig et al., Science, 313, 1642-1645, 2006; and T. Chen et al., Chem. Rev., 117, 7510-7537, 2017, the contents of which are herein incorporated by reference in their entirety.

The term “non-fluorescent species,” as used herein, generally refers to an entity having a molecular weight of up to 100 kDa (100 kilodaltons). The non-fluorescent species may, in some embodiments, have a molecular weight of up to or less than, e.g., 75 kDa, 50 kDa, 25 kDa, 20 kDa, 15 kDa, 5 kDa, 3 kDa, 2 kDa, 1 kDa, 500 Da, 100 Da, 50 Da, 20 Da, or 1 Da, or a molecular weight within a range bounded by any two of the foregoing values. The term “non-fluorescent” refers to the inability of a species to fluoresce (i.e., emit a fluorescent signal) when stimulated with light (i.e., electromagnetic radiation of any suitable wavelength) of same wavelength used to stimulate fluorescence in a fluorescent species in competition with the non-fluorescent species. In some embodiments, the non-fluorescent species does not fluoresce with any stimulation. In some embodiments, the non-fluorescent species can fluoresce when stimulated with light (electromagnetic radiation) of a certain wavelength, but will not fluoresce when stimulated with light capable of fluorescing the competitive fluorescent species. In other embodiments, the non-fluorescent species does not fluoresce at any stimulating wavelength. In some embodiments, the non-fluorescent species is an organic species, wherein the term “organic,” as used herein, refers to the presence of at least one carbon-hydrogen or carbon-halogen bond. The organic species is typically a molecule with a specific molecular weight. In other embodiments, the non-fluorescent species is a small inorganic molecule, such as carbon monoxide or hydrogen molecule, which have a specific molecular weight. In other embodiments, the non-fluorescent species is an inorganic species, such as metal or metal oxide nanoparticle or microparticle with size of, for example, 1 nm to 1 μm.

The term “fluorescent species,” as used herein, refers to any of the organic molecules or inorganic particles known in the art having an ability to fluoresce when stimulated with electromagnetic radiation of suitable wavelength. The term “fluorescent species” may also herein be used interchangeably with the term “fluorophore”. The fluorophores considered herein can absorb and emit light of any suitable wavelength. In some embodiments, it may be desired to select a fluorophore with particular absorption and emission characteristics. For example, in different embodiments, the fluorophore absorbs at nanometer (nm) wavelengths of 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, 500, 510, 520, 530, 540, 550, 560, 570, 580, 590, 600, 610, 620, 630, 640, 650, 660, 670, 680, 690, 700, 710, 720, 730, 740, 750, 760, 770, 780, 790, or 800 nm, or within a range bounded by any two of the foregoing values. In different embodiments, the fluorophore emits at any of the foregoing wavelengths, or within a range bounded by any two of the foregoing values, wherein it is understood that a fluorophore generally emits at a longer wavelength than the absorbed wavelength. The impinging electromagnetic radiation (i.e., which is absorbed by the fluorophore) can be in a dispersed form, or alternatively, in a focused form, such as a laser. Moreover, the absorbed or emitted radiation can be in the form of, for example, far infrared, infrared, far red, visible, near-ultraviolet, or ultraviolet.

In a first set of embodiments, the fluorescent species is an organic molecule, which generally contains at least one carbon-carbon bond and at least one carbon-hydrogen bond. In different embodiments, the organic fluorophore can include, for example, a charged (i.e., ionic) molecule (e.g., sulfonate or ammonium groups), uncharged (i.e., neutral) molecule, saturated molecule, unsaturated molecule, cyclic molecule, bicyclic molecule, tricyclic molecule, polycyclic molecule, acyclic molecule, aromatic molecule, and/or heterocyclic molecule (i.e., by being ring-substituted by one or more heteroatoms selected from, for example, nitrogen, oxygen and sulfur). In the particular case of unsaturated fluorophores, the fluorophore contains one, two, three, or more carbon-carbon and/or carbon-nitrogen double and/or triple bonds. In a particular embodiment, the fluorophore contains at least two (e.g., two, three, four, five, or more) conjugated double bonds (i.e., a polyene linker) aside from any aromatic group that may be in the fluorophore. In other embodiments, the fluorophore is a fused polycyclic aromatic hydrocarbon (PAH) containing at least two, three, four, five, or six rings (e.g., naphthalene, pyrene, anthracene, chrysene, triphenylene, tetracene, azulene, and phenanthrene) wherein the PAH can be optionally ring-substituted or derivatized by one, two, three or more heteroatoms or heteroatom-containing groups. In some embodiments, the fluorophore contains a polyalkyleneoxide group that contains at least two, three, or four alkyleneoxide units. In other embodiments, the fluorophore contains at least one sulfonic acid or sulfonate salt group.

In some embodiments, the organic fluorophore is a xanthene derivative (e.g., fluorescein, rhodamine, Oregon green, eosin, and Texas Red), cyanine or its derivatives or subclasses (e.g., streptocyanines, hemicyanines, closed chain cyanines, phycocyanins, allophycocyanins, indocarbocyanines, oxacarbocyanines, thiacarbocyanines, merocyanins, and phthalocyanines), naphthalene derivatives (e.g., dansyl and prodan derivatives), coumarin and its derivatives, oxadiazole and its derivatives (e.g., pyridyloxazoles, nitrobenzoxadiazoles, and benzoxadiazoles), pyrene and its derivatives, oxazine and its derivatives (e.g., Nile Red, Nile Blue, and cresyl violet), acridine derivatives (e.g., proflavin, acridine orange, and acridine yellow), arylmethine derivatives (e.g., auramine, crystal violet, and malachite green), and tetrapyrrole derivatives (e.g., porphyrins and bilirubins).

In some embodiments, the fluorophore is a streptocyanine (open chain cyanine) having the general structure:

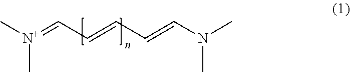

wherein n in formula (1) above can be, for example, precisely, at least, or no more than 0, 1, 2, 3, 4, 5, 6, 7, 8, or within a range therein. Other structures related to or derived from formula (1) are also considered herein, as amply described in Guieu, V., et al., Eur. J. Org. Chem., 2007, 804-810, which is incorporated herein by reference in its entirety.

In other embodiments, the fluorophore is a hemicyanine having the general structure:

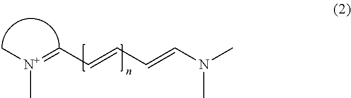

wherein n in formula (2) is as defined above. The arc in Formula (2) indicates a nitrogen-containing ring, such as pyrrolyl. The arc may alternatively represent a bicyclic ring system, such as a benzopyrrolyl fused ring system. Other structures related to or derived from formula (2) are also considered herein, as amply described in Stathatos, E., et al. Chem. Mater., 2001, 13, 3888-3892, and Yao, Q.-H., et al. J. Mater. Chem., 2003, 13, 1048-1053, which are incorporated herein by reference in their entirety.

In other embodiments, the fluorophore is a closed cyanine having the general structure:

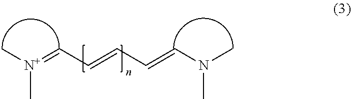

wherein n in formula (3) is as defined above.

In other embodiments, the fluorophore is a cyanine dye (i.e., cyanine-based fluorophore). The term “cyanine dye”, as used herein, refers to any of the dyes, known in the art, that include two indolyl or benzoxazole ring systems interconnected by a conjugated polyene linker. The cyanine dye typically contains at least two or three conjugated carbon-carbon double bonds, at least one of which is not in a ring, such as depicted in any of Formulas (1)-(3). The cyanine dye (or other type of dye) often contains at least two pyrrolyl rings. Some particular examples of cyanine dyes are the Cy® family of dyes, which include, for example, Cy2, Cy3, Cy3B, Cy3.5, Cy5, Cy5.5, Cy7, and Cy9. The term “cyanine moiety”, as used herein, generally includes the bis-indolyl-polyene or bis-benzoxazolyl-polyene system, but excludes groups attached to the ring nitrogen atoms in the indolyl or benzoxazolyl groups. The cyanine dyes may also include the Alexa® family of dyes (e.g., Alexa Fluor 350, 405, 430, 488, 500, 514, 532, 546, 555, 568, 594, 610, 633, 647, 660, 680, 700, 750, and 790), the ATTO® family of dyes (e.g., ATTO 390, 425, 465, 488, 495, 520, 532, 550, 565, 590, 594, 601, 615, 619, 629, 635, 645, 663, 680, 700, 729, and 740), and the Dy® family of dyes (e.g., DY 530, 547, 548, 549, 550, 554, 556, 560, 590, 610, 615, 630, 631, 631, 632, 633, 634, 635, 636, 647, 648, 649, 650, 651, 652, 675, 676, 677, 680, 681, 682, 700, 701, 730, 731, 732, 734, 750, 751, 752, 776, 780, 781, 782, and 831). The ATTO dyes, in particular, can have several structural motifs, including, coumarin-based, rhodamine-based, carbopyronin-based, and oxazine-based structural motifs.

The fluorophore (fluorescent species) may alternatively be an inorganic fluorophore, such as a metal, metal oxide, or quantum dot nanoparticle or microparticle capable of fluorescing when stimulated. The fluorescing ability may be an innate property arising from the composition of the particle, or the fluorescing ability may arise from fluorophore doping or surface conjugation to an organic fluorophore species. The fluorescent dopant may be, for example, a lanthanide ion, such as, Ce, Er, Gd, Dy, or Yb. Some examples of metal particle fluorophores include gold and silver particles. Some examples of metal oxide fluorescent particles include fluorophore-doped silica, titania, or zirconia particles. Some examples of quantum dot nanoparticles include particles having a zinc sulfide, zinc selenide, zinc telluride, cadmium sulfide, cadmium selenide, or cadmium telluride composition. A detailed description of fluorescent nanoparticles is provided in O. S. Wolfbeis, Chem. Soc. Rev., 44, 4743-4768, 2015, the contents of which are herein incorporated by reference in their entirety.

The material interacting with the fluorescent and non-fluorescent species is any material that contains sites that the fluorescent and non-fluorescent species can interact with. The term “interact,” as used herein, includes any physical or electronic contact between the material and the fluorescent and non-fluorescent species. Physical contact includes, for example, covalent bonding, dipole-dipole interaction, ionic bonding, and hydrogen bonding. Electronic contact includes transferring of electrons (e.g., oxidation or reduction), shifting or shuttling of electrons, or sharing or overlap of electrons. The material may be of any dimension suitable for viewing in a super-resolution optical microscope. The material may be, for example, of nanoscale dimension (e.g., 10-500 nm), microscale dimension (e.g., 500 nm to 100 microns), or macroscale dimension (e.g., 100 microns to 1 mm or even larger). In some embodiments, the material is an inorganic material. The inorganic material may be, for example, a catalyst material (e.g., support or active catalyst), such as a metal oxide material, such as the aluminas, silicas, aluminosilicates (including zeolites), clays, titanium oxides, zinc oxides, zirconium oxides, cerium oxides, niobium oxides, sol-gels, or vanadyl pyrophosphate. In other embodiments, the material is an organic material. The organic material may be, for example, a biological material (e.g., protein, oligopeptide, nucleic acid, oligonucleotide, polysaccharide, oligosaccharide, neurotransmitter, or lectin), synthetic polymer, or explosive.

In the imaging method, the material is first contacted (e.g., in “step (i)”) with a fluorescent species. The material and fluorescent species can be any such entities described above. The term “contacting,” as used herein, may be achieved directly or indirectly. In a direct contact process, the fluorescent species is pre-prepared (or otherwise obtained) and placed in contact with the material, such as by dissolving the fluorescent species in a liquid in which the material is also in contact. By directly contacting the fluorescent species with the material, the fluorescent species directly interacts with specific sites in the material and is not generated in situ at said specific sites of the material. In some embodiments, the specific sites are binding sites or binding pockets, such as in the case of the material being a receptor or enzyme or other protein. In an indirect contact process, the fluorescent species is produced in situ at specific sites of the material by catalytic or chemical conversion of a substrate non-fluorescent species (at the specific sites in the material) to the fluorescent species. Thus, in an indirect contact process, a substrate non-fluorescent species may be placed in contact with the material to result in production of the fluorescent species by interaction (e.g., by reactive or catalytic action) of the substrate species with the material.

Whether contacted directly or indirectly with the material, the fluorescent species has the ability to interact with specific sites in the material. The specific sites in the material may interact by, for example, a chemical process (e.g., oxidation, reduction, or a chemical bond transformation). An example of a chemical bond transformation is production of the fluorescent species from a substrate species at specific sites of the material, e.g., producing the fluorescent species in situ at said specific sites from a non-fluorescent precursor species that interacts with and undergoes catalytic transformation at the specific sites to produce the fluorescent species at the specific sites. Notably, when a fluorescent species is produced at specific sites of the material, the fluorescent species inherently interacts with the specific sites in the process of being produced at the specific sites. In other embodiments, the fluorescent species interacts with specific sites in the material by binding of the fluorescent species to specific sites in the material by any of the binding modes described above. In the event of binding occurring, the binding may be permanent (fixed) or fluxional. Moreover, the fluorescent species may itself interact with the material, or the fluorescent species may be bound to an organic or inorganic entity (e.g., molecule, macromolecule, or particle) that interacts with the material. In the latter case, the fluorescent species indirectly interacts with the material via the organic or inorganic entity.

In a subsequent step (e.g., “step (ii)”), fluorescence is induced in the fluorescent species, by means well known in the art, while the fluorescent species interacts with specific sites in the material. Fluorescence can be induced in the fluorescent species by any of the means well known in the art, typically by stimulating the fluorescent species with electromagnetic radiation of suitable wavelength. A first fluorescence signal is then measured over an area of the material to provide a first quantified distribution map of the fluorescent species in the material, by means well known in the art. As also well known in the art, the fluorescence signal can be measured in different ways, such as by measuring the signal intensity, wavelength, or blinking frequency. As is generally provided by super-resolution fluorescence microscopy techniques, the resolution of the first quantified distribution map is generally less than 100 nm.

In a next step (e.g., “step (iii)”), the material from step (ii), while interacting with the fluorescent species, is contacted with a non-fluorescent species, as described above, provided that the non-fluorescent species selectively interacts with the same specific sites as the fluorescent species. As the non-fluorescent species selectively interacts with the same specific sites as the fluorescent species, the non-fluorescent species is also herein referred to as a “competitive non-fluorescent species”.

In a subsequent step (e.g., “step (iv)”), fluorescence is again induced in the fluorescent species and the resulting second fluorescence signal is measured over an area of the material to provide a second quantified distribution map of the fluorescent species in the material, in the same manner described above in step (ii). Thus, fluorescence measured in the present step is made while the fluorescent and non-fluorescent species competitively interact with the same specific sites in the material.

A next step (e.g., “step (v)”) involves calculating the difference in intensity, wavelength, or blinking frequency between the first and second fluorescence signals over the area of material to provide a difference quantified distribution map based on the difference in signal intensity, wavelength, or blinking frequency between the first and second fluorescence signals over the area of material. Such calculations can be made by means well known in the art. Notably, the greater the interaction between the non-fluorescent species and material, the less interaction between the fluorescent species and material, which results in a decreased (i.e., “suppressed”) fluorescence signal. Thus, a larger difference in the fluorescence signal indicates a stronger interaction between the non-fluorescent species and material.

In particular embodiments, the difference calculation is particularly useful in determining the locations in the material engaging in the strongest interactions with the non-fluorescent species. For example, in the case of imaging a catalytic material interacting with a substrate molecule, the difference quantified distribution map can elucidate specific locations in the catalytic material (e.g., at edges or vertices) where the strongest interactions occur. Similarly, in the case of a protein, which may be, e.g., a receptor or enzyme, the difference quantified distribution map can elucidate specific locations in the protein where greatest interactions occur between the protein and non-fluorescent species, wherein the non-fluorescent species may be, for example, a candidate targeting agent or drug molecule. In specific embodiments, the receptor may be, for example, a human epidermal growth factor receptor (HER) or neurotransmitter receptor. In the case of an explosive, the difference quantified distribution map may detect the presence of an explosive and/or elucidate the type of explosive, such as may be present in trace amounts on a surface. The presently described method can also be used to detect fingerprint chemicals, and such detection can be used for mapping fingerprints or other prints useful for criminal investigations. Such information can be further useful in adjusting the design of the material or the non-fluorescent species to improve specific interactions, if applicable, between the material and non-fluorescent species to yield a particular efficacious effect (e.g., more efficient or more selective catalysis, or greater efficacy in treating a disease or condition, such as a cancer). Notably, imaging the interactions of the non-fluorescent species and material can also be used to generate an overall image of the material itself, the quality of which is also dependent on the density of specific sites as imaged in the difference quantified distribution map.

In particular embodiments, the COMPEITS super-resolution imaging method described herein is used to image chemical reactions that occur on a surface. The surface can be, for example, the surface of catalyst or support particles of any size, e.g., from single atoms to nanoclusters to micro- and macro-sized particles. The method is also applicable to such materials of any morphology or composition, such as layered double hydroxide microparticles, gold (Au) nanoparticles, Au nanorods, Au nanoplates, palladium (Pd) nanorods, Pd—Au nanostructures, Pt nanoparticles, zeolite crystals, TiO₂ nanorods, TiO₂ microparticles, BiVO₄ microparticles, and perovskites (e.g., SrTiO₃). The surface may also be of 2D materials that can function as catalysts, such as graphene, graphene oxide, heteroatom-doped graphene, MoS₂. The surface may also be an organic surface that possesses some catalytic activity, such as a reactive polymeric surface, covalent organic framework, metal-organic framework, or biomacromolecular surface. In some embodiments, the competing fluorescent species can be produced at the same specific sites of the catalyst by a fluorogenic reaction that produces the fluorescent species. In other embodiments, the competing fluorescent species is not produced at the same specific sites of the catalyst, but the competing fluorescent species interacts with the same specific sites as the non-fluorescent species.

In the case of the material being catalytic, the non-fluorescent chemical reaction occurring on the catalyst and being imaged may be, for example, hydroquinone oxidation and oxidation reactions of many other organic compounds, such as pollutants found in water, pharmaceuticals and carcinogenic aromatics (e.g., bisphenol A, bisphenol S, 2,4-dichlorophenol, 2-naphthol, and 1-naphthylamine, Methyl orange (MO), Rhodamine B, ethinyl estradiol, and propranolol hydrochloride). The non-fluorescent chemical reaction occurring on the catalyst and being imaged may also be a reduction reaction, such as CO₂ reduction. The catalytic reaction may alternatively be, for example, the epoxidation of alkenes, such as for the production of ethylene oxide, which typically occurs on silver catalysts. The catalytic reaction may alternatively be, for example, hydrocarbon cracking, which typically occurs on aluminosilicate catalysts.

In other particular embodiments, the COMPEITS super-resolution imaging method described herein is used to image molecular binding (or physical adsorption) processes that occur on certain types of surfaces. The surface can be, for example, any of the surfaces described above, or another solid surface that may or may not have catalytic properties but can adsorb molecules, such as carbon blacks, inert carbon nanotubes, and polymer fiber mats. The surface may alternatively be, for example, liquid surfaces or interfaces, such as lipid membranes in aqueous or non-aqueous solutions. The non-fluorescent species can be any molecule or particle that binds to a solid surface or liquid surface/interface. The non-fluorescent species may be, for example, a water contaminant, such as any of the following: i) hydrophobic or hydrophilic, or amphiphilic species (e.g., organic dyes, aliphatic and aromatic hydrocarbons), ii) organic or inorganic ions (e.g. carboxylates, sulfonates and halides), and iii) heavy metal cations (e.g., Cu²⁺, Hg²⁺, and Cr³⁺). The competitive fluorescent species is typically a fluorescent molecule or particle that adsorbs and desorbs reversibly on a surface.

In some embodiments, the COMPEITS method described herein is directed to the imaging of biological targets. The biological target may be non-fluorescent, such as a protein, such as HER1 and HER2 over-expressed by tumor cells, or neurotransmitters in the central nervous system, such as dopamine. The fluorescent species may be, for example, any randomly blinking, photoactivatable or photoconvertible fluorophores that possess some interactions with the non-fluorescent biological targets, wherein such interactions can cause a change in the intensity, blinking frequency or wavelength of the fluorophores.

In some cases, preliminary to conducting the method (i.e., before step (i)), an experimental procedure may be performed to determine whether competition exists between non-fluorescent and fluorescent species at specific sites in a material. The preliminary experiment may rely on bulk experimental procedures, such as NMR, UV-Vis, FTIR, fluorescence spectroscopy, or XPS to establish there is indeed competition between a non-fluorescent process and an auxiliary fluorescent process on a certain type of surface or in a certain type of medium.

Some exemplary systems for which the present invention can be applied to for imaging include those listed in the following table.

TABLE 1
Some examples of non-fluorescent systems/processes
that may be imaged at super resolution by COMPEITS

| Target non-fluorescent | Auxiliary (competitive) | |
|---|---|---|
| systems | fluorescent systems | Some applications |
| Unlabeled proteins that | Fluorophores whose | cell biology |
| are ubiquitously present in | fluorescence is quenched | cancer diagnosis |
| biological systems | once bound to proteins | drug delivery |
| e.g., HER1 and HER2 | e.g., indocyanine green, a | |
| overexpressed by tumor | clinically approved | |
| cells | molecular probe | |
| Neurotransmitters in the | Molecules that are | neuroscience |
| central nervous system | designed to fluoresce once | biosensing |
| that are non-fluorescent | bound to certain | |
| small organic molecules | neurotransmitters | |
| e.g., serotonin | e.g., NS715 molecule | |
| Nanoscale inorganic | Emissive systems whose | materials science |
| systems whose 2D or 3D | fluorescence or | nanotechnology |
| spatial information is of | photoluminescence is | energy conversion |
| interest | quenched when they are in | nano(bio)photonics |
| e.g., inorganic | the vicinity of the target | |
| nanoparticles or | inorganic systems. | |
| nanoclusters unevenly | e.g., fluorescein | |
| distributed on cell | isothiocyanate (26-28), | |
| membranes or two- | whose fluorescence can be | |
| dimensional materials | quenched by Au | |
| such as graphene and | nanoparticles | |
| MoS₂ | e.g., CdTe/CdS | |
| e.g., adsorption or | (core/shell) quantum dot, | |
| aggregation kinetics of | whose photoluminescence | |
| nanoparticles | can be quenched by Au | |
| | nanoparticles. | |
| Certain explosives that are | Emissive systems whose | explosive detection |
| non-fluorescent small | fluorescence can be | chemisensor |
| organic molecules | modulated by binding of | optimization |
| e.g., 2,4,6-trinitrotoluene, | explosives | |
| 2,4-dinitrotoluene, | e.g., semiconducting | |
| nitrobenzene, 2,4- | conjugated organic | |
| dinitrochlorobenzen, and | molecules | |
| p-nitrotoluene | e.g., single-walled carbon | |
| | nanotube/peptide | |
| | conjugates | |
| | e.g., carbon quantum dot | |

Examples have been set forth below for the purpose of illustration and to describe the best mode of the invention at the present time. However, the scope of this invention is not to be in any way limited by the examples set forth herein.

### EXAMPLES

### Overview

The following experiments demonstrate the above-described competition-enabled imaging technique with super-resolution (COMPEITS). The COMPEITS method provides quantitative super-resolution imaging of non-fluorescent processes. COMPEITS is based on the incorporation of competition into a single-molecule fluorescence-detection scheme. COMPEITS is herein demonstrated by investigating a photoelectrocatalytic reaction. Specifically a non-fluorescent surface reaction that is important for water decontamination on single photocatalyst particles is mapped with nanometer precision. The subparticle-level quantitative information of reactant adsorption affinities unambiguously decouples size- and shape-scaling laws on specific particle facets and uncovers a surprising biphasic shape dependence, leading to catalyst design principles for optimal reactant adsorption efficacy. With its ability to provide spatially resolved information on the behaviors of unlabeled, non-fluorescent entities under operando conditions, COMPEITS can interrogate a variety of surface processes in fields ranging from heterogeneous catalysis and materials engineering to nanotechnology and energy sciences.

Synthesis of BiVO₄ particles with a truncated bipyramid morphology.

BiVO₄ particles were synthesized by a hydrothermal procedure using a modified method reported by Li et al. (Nat. Commun. 4, 1432, 2013). Typically, 3 mmol NH₄VO₃ and 3 mmol Bi(NO₃)₃.5H₂O were dissolved in 30 mL of 1 M nitric acid solution, and the resulting solution was adjusted to about pH of 1 with ammonia solution. Next, the solution was hydrothermally treated at 80° C. for 48 hours, and the yellow solid powder was then separated by filtration, followed by washing with water and drying in air at 60° C. for 24 hours.

Ensemble photoelectrochemical measurements.

Ensemble-level photoelectrochemical measurements were performed with a potentiostat in a three-electrode configuration using BiVO₄-modifed ITO as the working electrode (prepared by drop-casting 0.5 mL of 10 mg ml⁻¹ BiVO₄ suspensions onto an ITO-coated slide, followed by annealing at 450° C. for 1 hour), a Pt wire as the counter electrode and a Ag/AgCl electrode as the reference electrode. A quartz cell with dimensions of 1 cm×4 cm×4 cm was employed as the working electrode chamber, which can be illuminated by an expanded 405 nm laser beam with a radius of 1.2 cm and a power density of 5.3×10⁻³ W cm⁻². The working electrode chamber was kept under an N₂ atmosphere, and separated from the counter electrode chamber by a salt bridge. The electrolyte solution was deaerated 0.1 M Na₂SO₄, 0.1 M pH 7.4 phosphate buffer.

COMPEITS imaging experiments and data analysis.

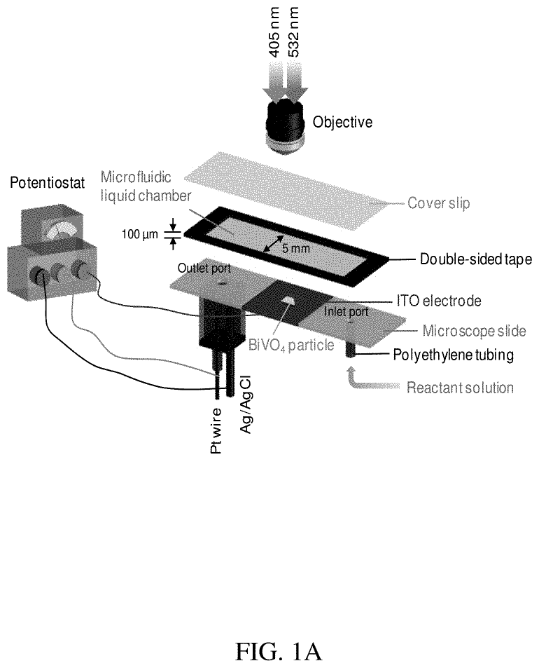

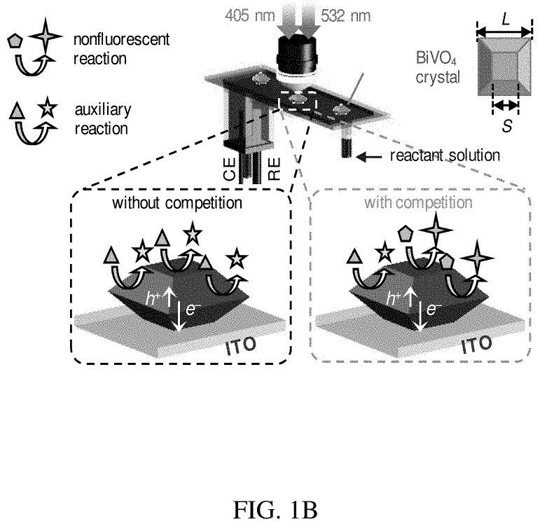

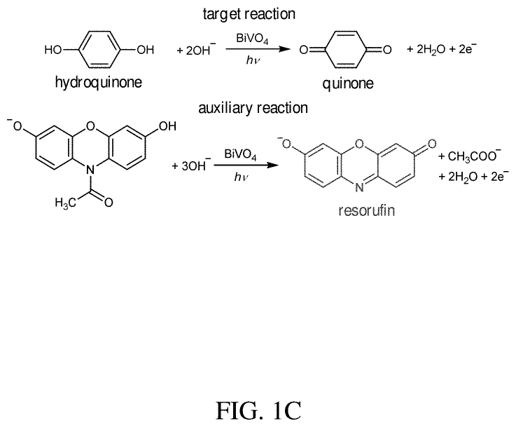

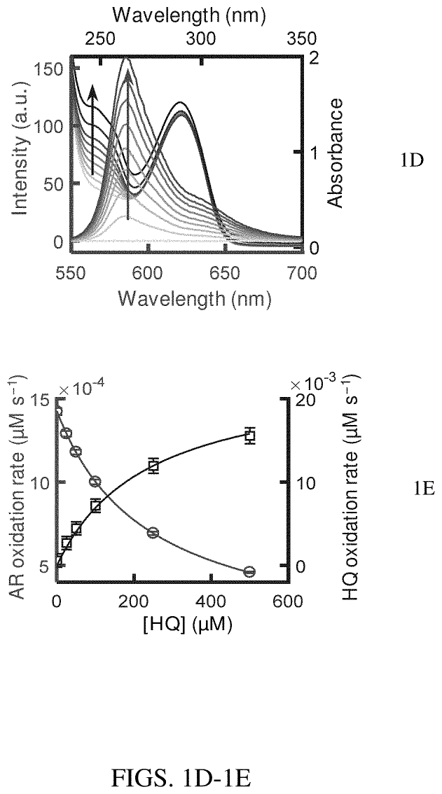

A schematic of the COMPEITS imaging experimental set-up is shown in FIG. 1A, which is based on single-molecule fluorescence microscopy with two-laser epifluorescence illumination on an inverted OLYMPUS IX71 microscope. BiVO₄ particles were spin-coated onto an ITO electrode and annealed at 450° C. for 1 hour, and then assembled into a three-electrode photoelectrochemical microfluidic cell (about 5-mm wide and 100-μm high) using double-sided tape sandwiched between an ITO electrode and a coverslip. The reactant solution (deaerated 0.1 M Na₂SO₄, 0.1 M pH 7.4 phosphate buffer with appropriate quantities of AR and HQ) was continuously supplied to the photoelectrochemical cell at a volumetric flow rate of 25 μL min⁻¹. The ITO electrode with dispersed BiVO₄ particles serves as the working electrode, the potential of which was controlled to be at 0.2 V by a potentiostat, and a platinum wire and a Ag/AgCl electrode were used as the counter and reference electrode, respectively. A continuous-wave circularly polarized 405 nm laser excites the BiVO₄ particles to generate charge carriers, and a 532 nm laser induces the fluorescence of the product resorufin. The two lasers were combined via a 425 nm long-pass dichroic mirror, focused onto the back aperture of a ×60 water immersion objective, and reflected by a 550 nm long-pass dichroic mirror to illuminate the sample in an epi-illumination geometry over a 70×60 μm² area. The fluorescence was collected through the same ×60 objective, passed through the 550 nm longpass dichroic mirror and a 580±30 nm emission filter, and imaged by an electron-multiplying charge-coupled device camera that was operated at a frame rate of 15-ms, which is controlled by ANDOR IQ3 software (Oxford Instruments).

First, to obtain the steady photoluminescence intensities of BiVO₄ particles, 1,000 fluorescence images were collected in the absence of the fluorogenic reactant (that is, AR), followed by collecting another 30,000 fluorescence images with appropriate quantities of AR and HQ. In a typical COMPEITS measurement, AR titration experiments in the absence of HQ ([AR]: 2-100 μM; 405 nm laser power density: 3.1×10⁻² W cm⁻²; 532 nm laser power density: 1.8×10² W cm⁻²) were performed first to determine K_{AR}. Next, HQ titration experiments in the presence of AR ([AR]: 50 nM; [HQ]: 0-2 mM; 405 nm laser power density: 1.2×10² W cm⁻²; 532 nm laser power density: 1.8×10² W cm⁻²) were carried out with the same set of BiVO₄ particles as those in the AR titration experiments to determine KHQ via equation (1′) by using the pre-quantified KAR (that is, the HQ titration data were fitted with equation (1′) using two floating parameters, k_{AR} and K_{HQ}, and a fixed value for K_{AR}). The fluorescence images were analyzed using a home-written MATLAB program, iQPALM (image-based quantitative photoactivated localization microscopy), the details of which have been reported in a previous study (T. Y. Chen et al., Nat. Commun. 6, 7445, 2015). In this work, a few modifications were made. Briefly, the fluorescence images first underwent corrections for the microscope stage drift and the photoluminescence of BiVO₄, followed by 2D Gaussian fitting to localize the positions of individual fluorescent product molecules, as well as a subsequent filtering process based on a quantitative single-molecule counting algorithm to remove noise contributions and spurious detections, and correct for unresolved multiple-molecule detections. Notably, there is no discernible difference in the photophysics of the probe molecule before and after introducing HQ (that is, the product molecule resorufin from AR oxidation).

The design and versatility of COMPEITS.

FIG. 1B illustrates the concept of COMPEITS, using a surface-catalyzed reaction as an example. A solid particle catalyzes an auxiliary fluorogenic reaction, whose fluorescent product molecules can be imaged and localized individually at nanometer resolution. The reaction of interest can be catalyzed by the same particle, but neither the reactants nor the products are fluorescent. This non-fluorescent reaction competes for the same surface sites on the catalyst particle where the fluorogenic reaction occurs, which leads to suppression of the fluorogenic reaction rate. The extent of suppression can be imaged at the same nanometer resolution as the fluorogenic reaction, yielding super-resolution spatial information on the non-fluorescent reaction.

COMPEITS is broadly applicable to many critical processes in chemistry, biology and materials science. It can spatially map non-fluorescent processes that suppress, enhance the intensity, or alter the emission wavelength of an auxiliary fluorescent process. For example, the target non-fluorescent process of COMPEITS could be competitions or inhibitions of surface- or enzyme-catalyzed reactions, such as fluorescence quenchers and redox mediators. The auxiliary (fluorescent) systems could be fluorogenic reactions (FIG. 1B), blinking molecules/particles or any fluorescent processes that can be imaged by super-resolution microscopy.

In the following experiments, COMPEITS was directed to the study of photoelectrocatalysis, a process of fundamental and technological importance for a wide range of applications, such as environmental remediation and energy conversion. Bismuth vanadate (BiVO₄) was selected as the photocatalyst because of its visible absorption when collecting solar energy and morphological and compositional tunability for photocatalytic performance (e.g., K. Sivula et al., Nat. Rev. Mater., 1, 15010, 2006; T. W. Kim et al., Science, 343, 990-994, 2014; and R. G. Li et al., Nat. Commun., 4, 1432, 2013). The BiVO₄ particles, as prepared, exhibited a tunable truncated bipyramid morphology that is quantifiable by a size parameter L and a shape parameter ξ (=S/L, see the inset of FIG. 1B): L ranges from ˜1 to 10 μm, whereas ξ varies from ˜0.3 (square-bipyramid-like) to ˜1 (square-plate-like).

The target non-fluorescent reaction in this experiment is the photoelectrocatalytic oxidation of hydroquinone (HQ) (FIG. 1C), a primary phenolic micropollutant in aquatic ecosystems and a prevalent redox mediator on (photo)electrodes and in biology (e.g., F. Brandl et al., Nat. Commun. 6, 7765, 2015; A. Alsbaiee et al., Nature 529, 190-194, 2016; and A. G. Thomas et al., Chem. Soc. Rev., 41, 4207-4217, 2013). The auxiliary fluorogenic reaction that competes with HQ oxidation is the oxidation of amplex red (AR) (FIG. 1C), which generates resorufin, a fluorescent molecule (J. B. Sambur, Nature 530, 77-80, 2016).

First, the experiment demonstrated the competition between AR and HQ oxidations photoelectrocatalytically by using a bulk BiVO₄ electrode (405 nm illumination with an applied potential of 0.2 V; all potentials refer to Ag/AgCl). The fluorescence of resorufin and the absorption of quinone, the two respective products (FIG. 1C), was monitored, by the fluorescence emission spectroscopy and UV-Vis absorption spectroscopy, respectively (FIG. 1D). Both products were observed, which confirmed that HQ and AR are oxidizable by the photogenerated holes in BiVO₄, as predicted from their oxidation potentials. There is no discernible HQ or AR oxidation without 405 nm illumination. More importantly, at a fixed AR concentration ([AR]), the rate of quinone formation increases with increasing [HQ], while the rate of resorufin formation decreases concurrently (FIG. 1E), which corresponds to competing reactions. By varying [AR], it was herein further shown that the AR-HQ system follows a competitive inhibition behavior, whereby the two reactants compete for the same catalyst surface sites.

The AR oxidation reaction rate follows saturation kinetics with competitive inhibition by HQ (D. Voet et al., Fundamentals of Biochemistry: Life at the Molecular Level, 4th Ed., Wiley, 2013):

$${v}_{AR} = \frac{{k}_{AR} {K}_{AR} [ AR ]}{1 + {K}_{AR} [ AR ] + {K}_{HQ} [ HQ ]} \qquad ( {1}^{′} )$$

where k_{AR} is the (specific) rate constant and v_{AR} the (specific) rate of the AR oxidation reaction; K_{AR} and K_{HQ} are the adsorption equilibrium constants for AR and HQ on the catalyst surface, respectively. Moreover, v_{AR}⁻¹ from equation (1′) scales linearly with [HQ], with the scaling constant K_{HQ}/(k_{AR}K_{AR}[AR]), which is directly proportional to K_{HQ}.

COMPEITS imaging of HQ oxidation on single particles.

To perform COMPEITS imaging on the photoelectrocatalytic oxidation of HQ, BiVO₄ particles were dispersed on a transparent indium-doped tin oxide (ITO) electrode in a microfluidic photoelectrochemical cell (FIG. 1B). Continuous wide-field 405 nm laser illumination generates charge carriers in BiVO₄. At a positive potential (for example, 0.2 V), AR and HQ are oxidized on the surfaces of BiVO₄ particles; the fluorescence of resorufin from AR oxidation is induced by a 532 nm laser and imaged at super-resolution.

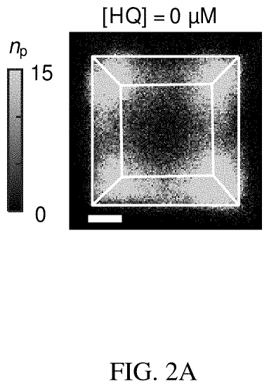

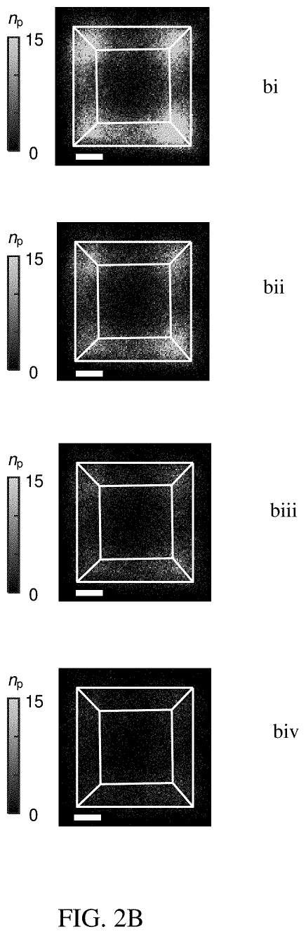

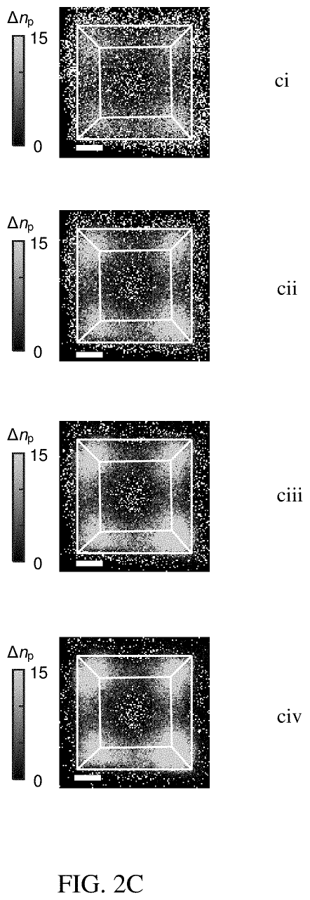

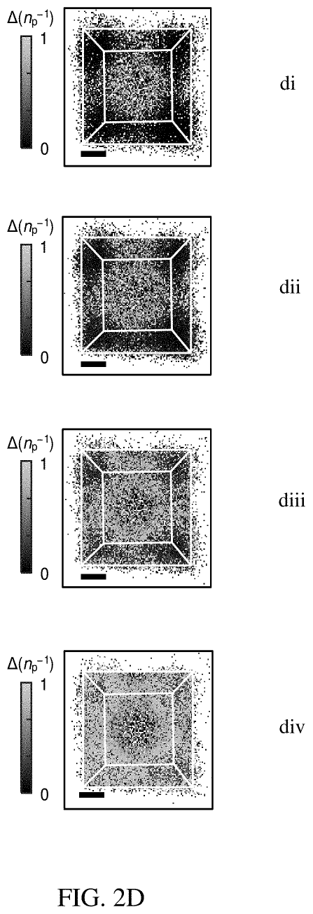

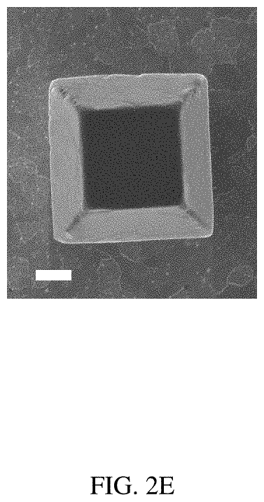

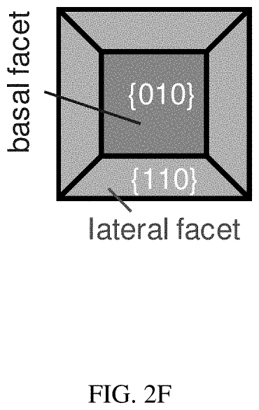

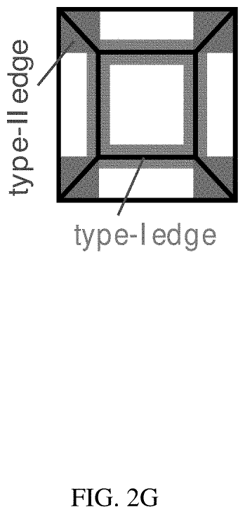

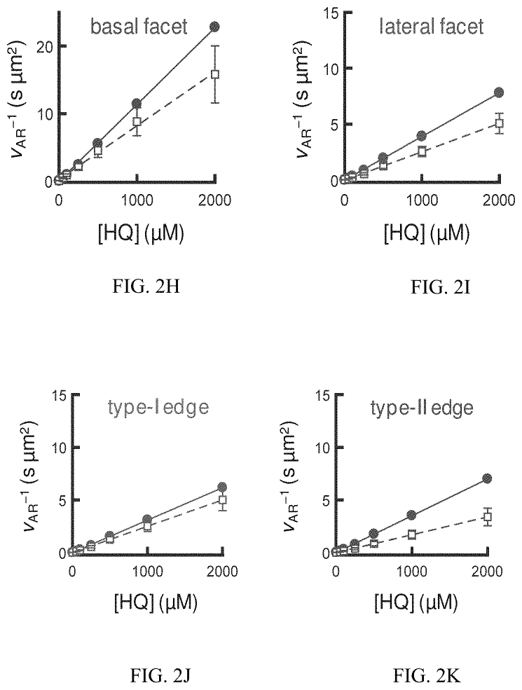

FIG. 2A shows a quantitative super-resolution image of the auxiliary fluorogenic AR oxidation reaction on a single BiVO₄ particle relative to its scanning electron microscopy (SEM) image (FIG. 2E), where each fluorescent product is localized to ˜40 nm precision (limited by the signal-to-noise ratio at a time resolution of 15 ms). Following the introduction of the non-fluorescent HQ oxidation reaction, the number of detected AR oxidation products (np) decreases substantially with increasing [HQ] across the particle surface, reporting the competition (FIG. 2B; panels bi-biv). The direct difference (that is, Δnₚ) images (FIG. 2C; panels ci-civ) show the expected trend: Δnₚ becomes larger with higher [HQ]. It is worth noting that the direct difference does not scale linearly with K_{HQ} (as can be deduced from equation (1′)), and thus, its value does not directly manifest the adsorption strength of the competitor HQ.

Alternatively, the inverse difference image (FIG. 2, panels di-div), which is herein termed the “COMPEITS image,” is more informative, and is obtained from calculating the difference in nₚ⁻¹ following the introduction of competition. From equation (1′):

$${v}_{AR}^{- 1} ∝ \frac{{K}_{HQ}}{{k}_{AR} {K}_{AR} [ AR ]} [ HQ ]$$

and, therefore, at any fixed [AR] and between two different [HQ], the difference in v_{AR}⁻¹; that is, Δ(v_{AR}⁻¹), is directly proportional to K_{HQ}. Moreover, nₚ over any time period is linearly proportional to v_{AR}; therefore, Δ(nₚ⁻¹) is also proportional to K_{HQ} and directly reflects the HQ binding affinity.

The COMPEITS images in FIG. 2, panels di-div, immediately show that, on this BiVO₄ particle, HQ adsorbs more strongly on the basal {010} facet than the lateral {110} facet. Moreover, within the lateral facets, HQ adsorption is weaker at the corners where two lateral facets intersect at an edge. These subparticle- and subfacet-level differences represent a quantitative super-resolution mapping of non-fluorescent chemical processes (that is, HQ adsorption for subsequent oxidation here), provided by COMPEITS. Such quantitative adsorption information is crucial for surface reactions, especially for reactions of micropollutants, such as HQ, whose low concentrations in the environment dictate that their surface reaction rates scale linearly with their adsorption affinities.

COMPEITS images allow each particle to be dissected into basal and lateral facets and v_{AR} titrated against the competing reactant concentration ([HQ]). At a fixed [AR], the v_{AR}⁻¹ of each facet increases linearly with increasing [HQ] (FIGS. 2H and 2I), with the slope directly reflecting the magnitude of K_{HQ}, as predicted by equation (1′). Fitting the data yields facet-specific K_{HQ} for each particle, which are inaccessible from ensemble-averaged measurements (K_{AR} in equation (1′) was obtained from an earlier [AR] titration; and v_{AR} was also corrected to take into account the different illuminations at the top and bottom facets of a BiVO₄ particle, although such corrections do not affect K_{AR} and K_{HQ}).

COMPEITS can provide quantitative information of the target non-fluorescent reaction as long as the binding affinities of both the pro-fluorescent and non-fluorescent reactants can be accurately determined by titration (that is, 1/K_{AR} and 1/K_{HQ} are in experimentally titratable concentration regimes). As long as the two reactants bind to the same or overlapping surface sites (which could be dependent on the relative molecule size), competition between the surface adsorption processes of the two molecules will occur.

Decoupling the size and shape effects of facet-specific reactant adsorption.

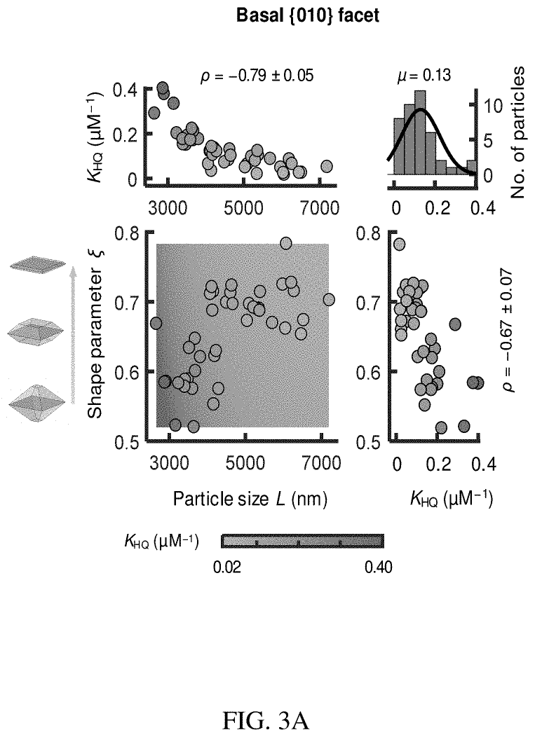

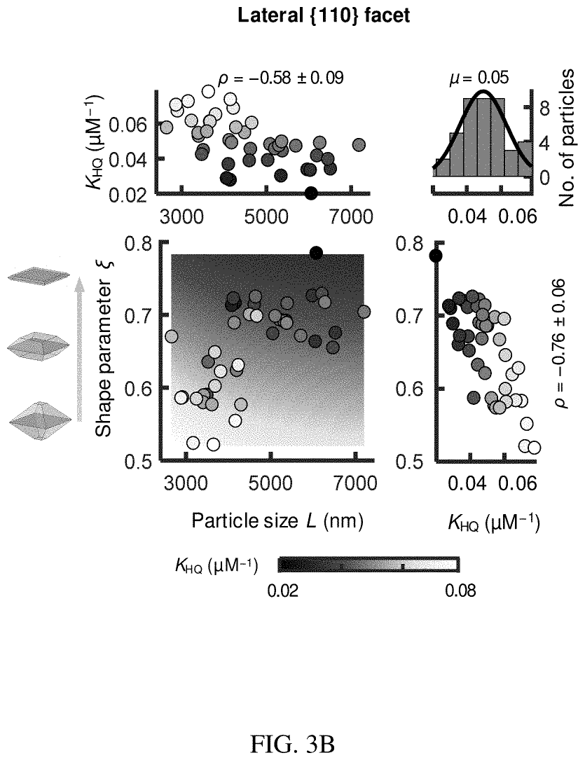

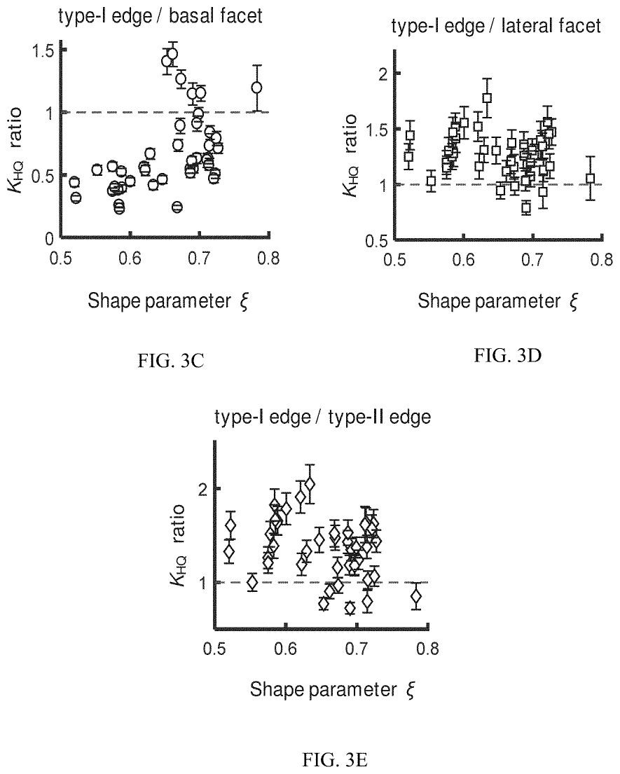

After pooling the results from many BiVO₄ particles, the K_{HQ} for the basal {010} and lateral {110} facets (K_{HQ}^{{}010} and K_{HQ}^{{110}}, respectively) show dispersion, but, on average, K_{HQ}^{{010}} is more than two times larger than K_{HQ}^{{110}}, which indicates stronger HQ adsorption on the basal facet (see the two histograms in FIGS. 3A and 3B), consistent with the COMPEITS images in FIG. 2D. Interestingly, K_{HQ}^{{010}} and K_{HQ}^{{110}} both show strong dependencies on L. At any fixed ξ, both K_{HQ}^{{010}} and K_{HQ}^{{110}} decrease asymptotically with increasing L, probably due to the size dependence of particle surface energy (FIGS. 3A and 3B, bottom left). These trends are clearer when K_{HQ}^{{010}} and K_{HQ}^{{110}} are projected onto the L axis (FIGS. 3A and 3B, top left): K_{HQ}^{{010}} and K_{HQ}^{{110}} exhibit strong negative correlations with L, with the Pearson cross-correlation coefficients (ρ) being about −0.8 and −0.6, respectively.

The adsorption equilibrium constants for the two facets, K_{HQ}^{{010}} and K_{HQ}^{{110}}, also show clear dependences on ξ (FIGS. 3A and 3B, bottom right). Both decrease asymptotically as the particle shape transitions from bipyramid-like to plate-like (that is, with increasing ξ). It can be hypothesized that this shape dependence may stem from their surrounding edges, which could differ from the facets in binding molecules and whose contributions around each facet vary with the particle shape. Thus, two edge regions (type I and type II) were examined between the basal and lateral facets, and between the lateral facets, respectively (FIG. 2G). Type-I edges surround basal and lateral facets, and thus, should affect the properties of both, whereas type-II edges should only contribute to those of the lateral facet. Hydroquinone titrations in COMPEITS images for these two edge regions gave their respective K_{HQ} (FIGS. 2J and 2K). For most BiVO₄ particles, the ratios of K_{HQ} between the type-I edge and the facets are clearly different from unity (FIGS. 3C and 3D), which indicates pronounced edge effects. The two types of edges also differ from each other, with the type-I edge on average having a larger K_{HQ} (FIG. 3E).

The size and shape dependences of facet-specific K_{HQ} were modeled using the following equation:

$${K}_{HQ} = {β}_{1} exp ( \frac{{β}_{2}}{L} ) exp ( - {β}_{3} ξ ) \qquad ( {2}^{′} )$$

where βᵢ (i=1, 2 or 3) are scaling parameters. Equation (2′) fits the data satisfactorily, giving the values of each βᵢ and allowing K_{HQ} to be predicted for individual facets over the experimental accessible ranges of the L and ξ values (FIGS. 3A and 3B, lower left, shaded surfaces).

Particle morphology design principles for optimal reactant chemisorption.

The fitted βᵢ parameters for the basal and lateral facets immediately allowed prediction of the overall HQ adsorption equilibrium constant (K_{HQ}^{whole}) for a whole BiVO₄ particle of any physically accessible size and shape (L≈1-10 μm; ξ≈0.3-0.8); K_{HQ}^{whole} is the surface-area-weighted average of its composing facets, because K_{HQ} is a per-surface-site-based property (note that the edge regions are part of the facets as defined in FIG. 2F). Compared with K_{HQ}^{{010}} and K_{HQ}^{{110}}, K_{HQ}^{whole} is a parameter that directly assesses how effectively a whole BiVO₄ catalyst particle adsorbs the target pollutant HQ at the per-surface site level.

More importantly, the following equation can be used to define and predict:

$${ω}_{HQ} ≡ {K}_{HQ}^{whole} \frac{A}{V} \qquad ( {3}^{′} )$$

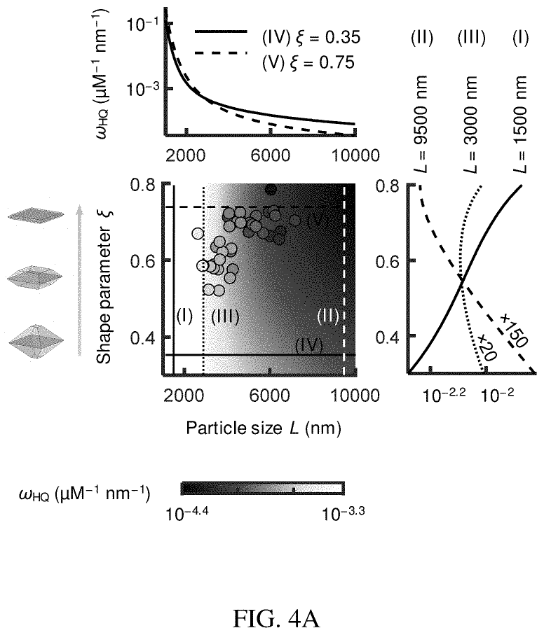

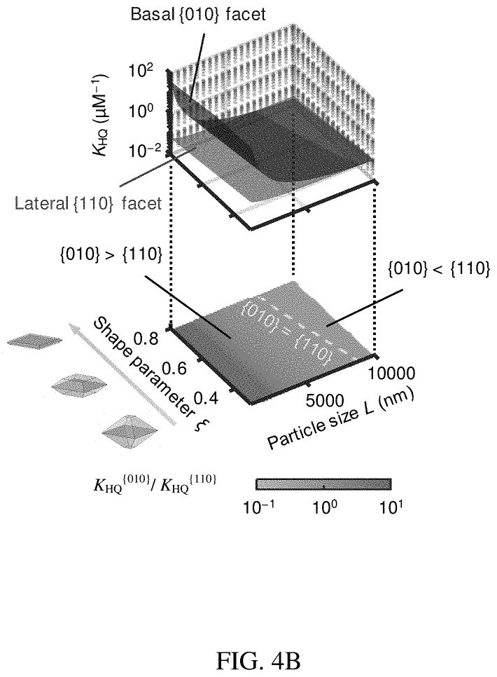

which normalizes K_{HQ}^{whole} by the particle volume (V) and multiplies it by the particle surface area (A). As such, ω_{HQ} quantifies the particle's overall capability of adsorbing the aqueous micropollutant HQ on its entire surface at the per-unit-mass level. The material's economy in assessing the adsorption efficacy of the catalyst particle is therefore taken into account by ω_{HQ}. The values of ω_{HQ} predicted from the fitted βᵢ parameters agree well with the experimental values obtained from whole particle COMPEITS titrations (FIG. 4A). The global maximum of ω_{HQ} corresponds with the smallest possible plate-like particles (for example, ξ=0.8, L=1 μm). At any fixed ξ, HQ always decays with increasing L. Moreover, plate-like particles (particles with larger ξ) exhibit steeper decays with increasing L than bipyramid-like particles (particles with smaller ξ) (FIG. 4A, top). This is understandable because, compared with bipyramid-like particles, plate-like particles comprise a larger fraction of the basal {010} facet, whose HQ adsorption ability decays more quickly with increasing L than that of the lateral {110} facet (that is, the size-scaling parameter β₂ for K_{HQ}^{{010}} is larger than for K_{HQ}^{{110}}).

Depending on L, the unit-mass-level whole-particle adsorption equilibrium constant ω_{HQ} shows three distinct dependences on ξ (FIG. 4A, right). For smaller particles (L<˜2.3 μm), the optimal shape for larger ω_{HQ} is plate-like (larger ξ), whereas for larger particles (L>˜9 μm) a bipyramid-like shape (smaller ξ) is better. Interestingly, for particles of intermediate sizes (˜2.3 μm<L<˜9 μm), ω_{HQ} versus ξ shows a biphasic behavior with a minimum; the optimal shape to maximize ω_{HQ} is either plate-like or bipyramid-like, but not a truncated bipyramid. These distinct behaviors accentuate the complexity of catalyst particle properties and represent a new identification of size- and shape-optimized catalyst particles, which is made possible by COMPEITS for reactant adsorption in a micropollutant degradation reaction here.

To understand the three distinct shape dependences of ω_{HQ}, K_{HQ}^{{010}} was compared with K_{HQ}^{{110}} in the physically accessible (L, ξ) space (FIG. 4B, top). Although on average K_{HQ}^{{010}}>K_{HQ}^{{110}}, this relation is not always true, and is valid only for smaller particles (smaller L). When L increases, a cross-over line appears because of the steeper decays of K_{HQ}^{{010}} with increasing L (yellow dashed line, FIG. 4B, bottom), after which the relation reverses. This cross-over behavior underlies the three different shape dependences of ω_{HQ} (FIG. 4B, bottom). When L is very small, K_{HQ}^{{}010}>K_{HQ}^{{110}}, and a plate-like shape that has more basal {010} facets thus has a larger ω_{HQ}. Conversely, when L is very large, K_{HQ}^{{010}}<K_{HQ}^{{110}}, and a bipyramid-like shape that has more lateral {110} facets thus has a larger ω_{HQ}. At the intermediate L values, a transition regime exists, where the optimal shape for large ω_{HQ} is either plate- or bipyramid-like. The boundaries of the transition regime for ω_{HQ} (FIG. 4A, lower left) are shifted from the cross-over line of K_{HQ} (FIG. 4B, bottom), because ω_{HQ}, which is a unit-mass-based quantity, contains the surface-to-volume ratio (A/V) that is also size and shape dependent.

### Discussion

The above-described COMPEITS method has been used to image and quantify at super-optical resolution the chemisorption of the non-fluorescent reactant molecule HQ, a micropollutant in aquatic ecosystems, on single BiVO₄ photocatalyst particles under photoelectrocatalysis conditions. This quantitative imaging permits unambiguous deconvolution of the effects of size and shape on the properties of specific facets of single catalyst particles. It has herein been surprisingly found that the HQ binding affinity on each facet exhibits particle shape dependence, and this shape dependence originates from pronounced edge effects, whereby different particle shapes give rise to varying contributions of edges to each facet. Moreover, the overall HQ adsorption efficacy of a whole particle exhibits three distinct types of shape dependences. In particular, within an intermediate size regime, this overall adsorption efficacy shows striking biphasic dependences on the particle shape. These insights offer a basis for the rational design of photocatalysts for optimal water decontamination performance, fulfilling a need for combined size and shape engineering of catalyst particles.

COMPEITS could, in principle, image a broad range of non-fluorescent processes at nanometer resolution, in situ and under operando conditions. The application of COMPEITS here yielded particle-size/shape-decoupled information for an important pollutant degradation reaction on specific particle facets. Notably, for the HQ oxidation reaction studied here, the HQ adsorption equilibrium constant (that is, a thermodynamic property of the surface chemisorption reaction) could be quantified at nanometer spatial resolution, but the reaction rate of the subsequent catalytic conversion to quinone could not be determined. Nevertheless, in the case of photocatalytic degradation of organics for water decontamination, the majority of aqueous contaminants are pollutants with low solubilities in water (for example, polycyclic aromatic hydrocarbons, pesticides, pharmaceuticals and endocrine disrupting compounds). At the low-concentration regime, the degradation reaction rate on the catalyst surface scales linearly with the adsorption equilibrium constant of the reactant (X. C. Zhou et al., J. Am. Chem. Soc., 132, 138-146, 2010; X. C. Zhou et al., Nat. Nanotechnol., 7, 237-241, 2012). The information on the reactant adsorption could thus guide the design of photocatalysts to maximize pollutant degradation reaction kinetics.

COMPEITS is well poised to provide spatially resolved, quantitative information on molecular adsorption on a variety of diverse solid surfaces, which is a fundamental phenomenon that has broad implications in various fields of inquiry. For example, COMPEITS could be used to reveal optimal binding sites and thus predict the optimal size, shape, or their combination, for an adsorbent material to achieve high separation efficiency, low energy cost and enhanced molecular selectivity. Such design rules are of paramount importance for chemical separation processes, which account for about 10-25% of the world's energy consumption (D. S. Scholl et al., Nature, 532, 435-437, 2016; X. Mao et al., Energy Environ. Sci., 11, 2954-2963, 2018). More broadly, COMPEITS is a potentially powerful tool for advancing materials science and nanotechnology. COMPEITS is suitable for elucidating the molecular binding processes that occur in several material systems of imminent importance, such as graphene-based materials and covalent organic frameworks. Such knowledge would be directly conducive to addressing fundamental questions in materials engineering, such as where small molecules bind preferentially (for example, edge sites versus basal plane in 2D materials), and how the distribution of binding locations affects the optical, electronic, and magnetic properties of these materials.

While there have been shown and described what are at present considered the preferred embodiments of the invention, those skilled in the art may make various changes and modifications which remain within the scope of the invention defined by the appended claims.

What is claimed is:

1. A method for super-resolution imaging of interactions between a non-fluorescent species and a material, the method comprising:
(i) contacting the material with a fluorescent species, wherein the fluorescent species selectively interacts with specific sites in the material;
(ii) inducing fluorescence in said fluorescent species, and measuring a first fluorescence signal over an area of the material to provide a first quantified distribution map of said fluorescent species in said material, wherein the resolution is less than 100 nm;
(iii) further contacting the material with a competitive non-fluorescent species that selectively interacts with the same specific sites as the fluorescent species;
(iv) inducing fluorescence in said fluorescent species while in the presence of said competitive non-fluorescent species, and measuring a second fluorescence signal over an area of the material to provide a second quantified distribution map of said fluorescent species in said material, wherein the resolution is less than 100 nm; and
(v) calculating the difference in intensity, wavelength, or blinking frequency between the first and second fluorescence signals over the area of material to provide a difference quantified distribution map based on the difference in signal intensity, wavelength, or blinking frequency between the first and second fluorescence signals over the area of material.

2. The method of claim 1, wherein contacting the fluorescent species with the material in step (i) occurs by an indirect contact process in which the fluorescent species is produced in situ at said specific sites by catalytic conversion of a substrate non-fluorescent species, at said specific sites in the material, to the fluorescent species.

3. The method of claim 1, wherein contacting the fluorescent species with the material in step (i) occurs by a direct contact process in which the fluorescent species is directly contacted with the material to directly interact with said specific sites and is not generated in situ at said specific sites of the material.

4. The method of claim 1, wherein the material is an inorganic material possessing catalytic ability at said specific sites, and said fluorescent species and competitive non-fluorescent species selectively interact with the same specific sites.

5. The method of claim 4, wherein the fluorescent species is produced in situ at said specific sites from a non-fluorescent precursor species that interacts with and undergoes catalytic transformation at said specific sites to produce the fluorescent species at the specific sites, and the competitive non-fluorescent species selectively interacts with the same specific sites.

6. The method of claim 4, wherein the inorganic material is an oxide material.

7. The method of claim 4, wherein the inorganic material undergoing super-resolution fluorescent imaging is a particle.

8. The method of claim 1, wherein the material is an organic material.

9. The method of claim 8, wherein the organic material is a synthetic polymer.

10. The method of claim 8, wherein the organic material is an explosive.

11. The method of claim 8, wherein the organic material is a biological material.

12. The method of claim 11, wherein the biological material is a protein.

13. The method of claim 12, wherein the specific sites in the protein are binding sites, and said fluorescent species and competitive non-fluorescent species selectively interact with the same specific binding sites.

14. The method of claim 12, wherein the protein is a receptor.

15. The method of claim 14, wherein the specific sites in the receptor are binding sites, and said fluorescent species and competitive non-fluorescent species selectively interact with the same specific binding sites.

16. The method of claim 14, wherein the receptor is a human epidermal growth factor receptor (HER).

17. The method of claim 14, wherein the receptor is a neurotransmitter receptor.

18. The method of claim 12, wherein the protein is an enzyme.

19. The method of claim 18, wherein the specific sites in the enzyme are binding pockets, and said fluorescent species and competitive non-fluorescent species selectively interact with the same specific binding pockets.

20. The method of claim 12, wherein the biological material is a neurotransmitter, and said fluorescent species and competitive non-fluorescent species selectively interact with the same neurotransmitter.
